(19) United States
(12) Patent Application Publication
(10) Pub. No.: US 2015/0153259 A1
(43) Pub. Date: Jun. 4, 2015

(54) MULTI-PARAMETER HIGH GRADIENT MAGNETIC SEPARATOR AND METHODS OF USE THEREOF

(71) Applicant: BioMagnetic Solutions, LLC, State College, PA (US)

(72) Inventors: Paul A. Liberti, Naples, FL (US); Jason R. Stephens, State College, PA (US); Todor R. Khristov, State College, PA (US); Theodore L. Liberti, State College, PA (US)

(21) Appl. No.: 14/559,109

(22) Filed: Dec. 3, 2014

Related U.S. Application Data
(60) Provisional application No. 61/911,163, filed on Dec. 3, 2013.

(51) Int. Cl. G01N 1/44; G01N 1/04

(52) U.S. Cl. CPC G01N 1/44; G01N 1/04

(57) ABSTRACT

Disclosed is a high gradient magnetic separation apparatus for recovering magnetic ally labeled target entities from viscous and/or complex test media. The target entities are captured on a ferromagnetic element in which a magnetic field gradient is induced by a magnetic field source. The apparatus is designed to perform various operations on captured target entities. Methods of using the apparatus are also disclosed, e.g., for isolation of circulating tumor cells.

### CROSS-REFERENCE TO RELATED APPLICATIONS

The present application claims the benefit of U.S. Provisional Patent Application No. 61/911,163, filed Dec. 3, 2013, the entire disclosure of which is incorporated by reference herein.

### BACKGROUND OF THE INVENTION

Various laboratory and clinical procedures employ bio-specific affinity reactions. Such reactions are commonly used in diagnostic testing of biological samples, or for the separation or enrichment of a wide range of target substances, especially biological entities such as cells, proteins, nucleic acid sequences, and the like.

In addition to using some physical property of a target entity (e.g. size, charge, and density), various methods are available for analyzing or separating the above-mentioned target substances based upon complex formation between the substance of interest and one or more other substance to which the target substance specifically binds. Separation of complexes from unbound material may be accomplished gravitationally (e.g. by settling, centrifugation or density gradient means), or by filtration or by means of beads coupled to the target substance. If desired, such particles or beads may be made magnetic to facilitate the bound/free separation step or the enrichment step.

### Magnetic Particles

Magnetic particles are well known in the art, as is their use in immune and other bio-specific affinity reactions. See, for example, U.S. Pat. No. 4,554,088, Immunoassays for Clinical Chemistry, pp. 147-162, Hunter et al. eds., Churchill Livingston, Edinborough (1983) and the enrichment of rare cells such as Circulating Tumor Cells [CTC] (E, Racila; D. Euhus; A. J. Weiss; C. Rao; J. McConnell; L. W. M. M. Terstappen; J. W. Uhr PNAS 1998, 95, 4589-4594).

Generally, any material which facilitates magnetic or gravitational separation may be employed for this purpose. For a review of the biological applications of magnetic nanoparticles see Colombo et al., Chem. Soc. Rev. 20, 2012, 41, 4306.

Magnetic particles generally fall into two broad categories. The first category includes particles that are permanently magnetizable, or ferromagnetic; and the second comprises particles that demonstrate bulk magnetic behavior only when subjected to a magnetic field. The latter are referred to as magnetically responsive particles. Materials displaying magnetically responsive behavior are sometimes described as superparamagnetic. However, materials exhibiting bulk ferromagnetic properties, e.g., magnetic iron oxide may aptly be characterized as superparamagnetic when provided in crystals of about 30 nm or less in diameter. Larger crystals of ferromagnetic materials, by contrast, retain permanent magnet characteristics after exposure to a magnetic field and tend to aggregate thereafter due to strong particle-particle interaction (Aoshima, M.; Satoh, A. J. Coll. Inter. Sci. 2005, 288, 475-488; Aoshima, M.; Satoh, A. J. Coll. Inter. Sci. 2004, 280, 83-90.).

In addition to being characterized by their magnetic nature, magnetic particles can be divided into two other broad categories based on size. Particles whose diameters are about 300 nanometers (nm) or less are sufficiently small that they remain stable in solution and exhibit true colloidal behavior. Such materials have been referred to as ferrofluids and many exhibit the characteristics of classical ferrofluids, e.g., increased viscosity and density when subjected to a magnetic field.

Biologically active ferrofluids, i.e. magnetic particles about 300 nm or less that are coated with antibodies, binding proteins, enzymes etc., such as those described in U.S. Pat. No. 4,452,773 to Molday and U.S. Pat. No. 4,795,698 to Owen et al. relating to polymer-coated, sub-micron size colloidal superparamagnetic particles, exhibit true colloidal behavior and do not exhibit an appreciable tendency to separate from aqueous suspensions for observation periods as long as several days to several months to even years. The '773 patent discloses a process for preparing dextran coated colloidal magnetic particles by the formation of magnetite in the presence of dextran. The '698 patent describes the manufacture of such particles by precipitation of a magnetic species in the presence of a bio-functional polymer as well as a spectrum of non-biologically active polymers. The structure of the resulting particles in both cases have been found for the most part to be a micro-agglomerate in which one or more ferromagnetic crystallites having a diameter of 5-10 nm are embedded within a polymer body having a diameter on the order of 30-100 nm.

Another method for producing such superparamagnetic colloidal particles is described in U.S. Pat. No. 5,698,271 to Liberti et al. In contrast to the particles described in the '698 and '773 patents, these latter particles are produced by directly coating a bio-functional polymer onto a pre-formed superparamagnetic crystalline magnetite that has been disrupted to a quasi-stable colloid, typically by sonication. The resulting particles exhibit a significantly larger magnetic moment than those of the '698 and'773 patents.

The above mentioned ferrofluids, because of their colloidal nature, have several advantages over larger magnetic particles in that: (1) they exhibit diffusion controlled reaction kinetics, thus making stirring unnecessary, (2) they are homogeneous solutions and accordingly can be handled by pipette with great accuracy, (3) based on their sizes, and the relationship between size and surface areas, these materials have extraordinary surface areas per unit mass, so that only very small masses of particles need be used in any particular binding reaction, and (4) because of the small mass volumes required, as stated in item 3, processing steps with ferrofluids are simplified as they can be magnetically monolayered, which facilitates removal of non-bound entities, subsequent reactions and a variety of readout reactions.

A variety of relatively large magnetic particles (>0.7 microns) have also been found to be very useful in magnetic separations. These materials also exhibit superparamagnetic behavior because they are typically polymer spheres into which have been imbedded magnetite crystals that are indeed superparamagnetic. Magnetic particles ranging from 0.7-1.5 microns have been described in the patent literature, including, by way of example, U.S. Pat. Nos. 3,970,518; 4,018,886; 4,230,685; 4,267,234; 4,452,773; 4,554,088; 4,659,678, 5,512,332; 5,698,271 and 7,169,618.

### Magnetic Separation

The magnetic force on a particle, Fₘ is given by the equation

Fₘ=μₒMₚVₚ∇H,

in which μₒ is the permeability of free space, Mp is the magnetization of the particle, Vp is the volume of the particle and ∇H is the gradient of the magnetic field. Since the magnetic force on a particle is proportional to its volume, the smaller the particle the more difficult it is to capture.

### External Magnetic Gradient Devices

Magnetic forces or magnetic gradients are a consequence of magnetic flux line circuits formed by single magnets (permanent or electro) or by the spatial arrangement and orientation of more than one magnet. As is well known in the art, such circuits, and consequently magnetic gradients, can be greatly influenced by their pole piece design. Devices that generate magnetic forces or gradients by such means are generally referred to as external gradient devices. See, e.g., U.S. Pat. No. 6,361,749. Such devices generally are limited in the force they can generate to about 12-14 kGauss/cm.

Magnetic separation techniques are well known wherein an external magnetic field gradient is applied to a fluid medium in order to separate ferromagnetic and superparamagnetic bodies from a fluid medium. For example, micron size ferromagnetic, permanently magnetized, particles or such particles containing substantial amounts of superparamagnetic crystals are readily removed from solution by means of placing a single small rare-earth magnet near a container holding such material. The magnetic gradient produced by, for example, the magnetic circuit of a single disc magnetic (typically about 1 cm diameter by 2-3 mm thickness) is generally quite adequate. A variety of such magnetic separation devices are commercially available. These devices employ a single relatively inexpensive permanent magnet located external to a container holding the test medium. Examples of such magnetic separators are the MAIA Magnetic Separator manufactured by Serono Diagnostics, Norwell, Mass., the DYNAL MPC-1 manufactured by DYNAL, Inc., Great Neck, N.Y. and the BioMag Separator, manufactured by Advanced Magnetics, Inc., Cambridge, Mass. A specific application of a device of this type in performing magnetic solid-phase radioimmunoassay is described in L. Hersh et al., Clinica Chemica Acta, 63: 69-72 (1975). A similar magnetic separator, manufactured by Ciba-Corning Medical Diagnostics, Walpole, Mass. is provided with rows of bar magnets arranged in parallel and located at the base of the separator. This device accommodates 60 test tubes, with the closed end of each tube fitting into a recess between two of the bar magnets. A multi well micro-titer plate separator, which is the subject of U.S. Pat. No. 7,258,799, assigned to Dexter Magnetic Technologies, Fremont, Ca utilizes the uniformity of field lines along the side of a long magnet, as well as the gradient to the side of such a magnet, to create uniform collection of magnetic materials over a relatively large area. Dexter Magnetic Technologies also manufactures a variety of external gradient devices for performing separations from vessels that range from test tubes to large cylindrical containers.

More sophisticated external gradient devices were introduced by Liberti et al. (U.S. Pat. Nos. 5,186,827; 5,299,084; 5,466,574). These devices employ quadrupole and hexapole magnet arrangements to create radial gradients. In addition to creating substantially higher magnetic gradients than in the aforementioned prior art, such devices, because of the radially directed gradients, are capable of monolayering magnetic entities to be separated. This innovation permitted separations of colloidal magnetic materials (generally >100 nm to about 300 nm) to be done in standard laboratory test tubes, whereby when placed in such devices magnetic materials are pulled to the inside walls of the vessel. The use of colloidal magnetic nanoparticles (ferrofluids) in these devices, with their extremely high binding surfaces per gram enables the use of small quantities of reagent due to the influence of the radial magnetic gradient. In this way, monolayering of magnetic material and consequently target substance can be achieved. One consequence of monolayering is that target materials can be washed free of contaminants without resuspension. The principles of radial magnetic fields and monolayering were employed by Immunicon Corporation (Huntingdon Valley, Pa) in the development of its CTC CellSearch® system that is currently sold by Veridex, a Division of Johnson & Johnson. On Jun. 1, 2013, Veridex changed its name to Janssen Diagnostics, LLC, also a division of the Johnson & Johnson family of companies. These same principles have also been used to develop rapid high sensitivity immunoassays (Rao and Liberti, U.S. Pat. No. 5,660,990). Improvements to quadrupole and hexapole separation efficiency can be achieved by incorporating interpole magnets as disclosed in Sterman et al (U.S. Pat. No. 6,451,207). Such designs appear to create somewhat higher gradients than standard quadrupole magnets but are comparatively expensive and difficult to manufacture. Precelleon, Columbus, Ohio offers such a system.

Another source of external gradient devices, nearly identical to Liberti '827, '084 and '574 is StemCell Technologies Inc., Vancouver, BC.

Davis et al (U.S. Pat. No. 8,071,395) disclosed an external gradient device for capturing mammalian cells that uses magnetic rods (neodymium, iron and boron magnets in one embodiment) to generate gradients. By tapering and other shaping of the rod ends, substantial magnetic gradients are achievable at the ends of such rods. When the rods are placed in a solution containing magnetically labeled cells (Dynabeads, Lifetechnolgies) and swirled so as to bring the rods in contact with labeled cells as well as to keep the cells and Dynabeads suspended, target cells are collected on the rod tips. Other means of creating an external gradient that can collect magnetic entities directly on their surfaces have been employed wherein metal rods that can be magnetized are affixed to the pole face of a strong magnetic (not unlike the construction of magnetic screwdrivers as in U.S. Pat. No. 2,260,055). U.S. Pat. No. 5,567,326 to Ekenberg and Brisco describe such a device.

### Internal Magnetic Gradient Devices

An alternative means for generating a magnetic gradient is to induce a magnetic field on a ferromagnetic member via an external field. The interaction of the induced magnetic field with the external field can result in the creation of incredibly high magnetic gradients (hundreds of kGauss/cm). The generation of magnetic forces in this manner is well known in the art. Devices using this principle are referred to as internal gradient devices, and are widely employed in what is referred to as high gradient magnetic separation [HGMS] (Oder, R. R., “High gradient magnetic separation theory and applications,” Magnetics, IEEE Transactions on, vol. 12, no. 5, pp. 428, 435 September 1976).

Maxwell's equation for the magnetic or field gradient, grad B, which can be induced, e.g., on a ferromagnetic wire of diameter D and of magnetization M by an external magnetic field, is given by the equation:

grad B=2πMD²/4R²

where R is the distance from the center of the wire. As can be seen from the above equation, the gradient decreases as the inverse square of R.

TABLE I
Induced Magnetic Gradients as a Function of
Wire Diameter and R

| Wire | | | | |
|---|---|---|---|---|
| Diameter | grad | | | grad B |
| surface | B_{at surface} | R_{at 4 kG/cm} | R_{at 2 kG/cm} | at sleeve |
| (.5 mm wall) | (mm) | (kGauss/cm) | (mm) | (mm) |
| 0.1 | 1260 | 0.3 | 0.43 | |
| 0.5 | 251 | 1.0 | 1.25 | |
| 1.0 | 126 | 1.8 | 1.99 | 15.7 |
| 2.0 | 63 | 2.5 | 3.15 | 18.6 |
| 3.0 | 42 | 3.3 | 4.13 | 17.6 |

Table I lists magnetic gradients (grad B) induced on the surfaces of wires with different diameters as well as the distances from each wire where grad B is 4 and 2 kGauss/cm, respectively. As shown, for a 0.1 mm diameter wire (100 micron) there is a tremendous gradient at the wire surface (1260 kGauss/cm) but within 0.25 mm (250 microns) and 0.38 mm of the wire surface the gradient is reduced to 4 kGauss/cm and 2 kGauss/cm, respectively. The calculated gradient for a 3.0 mm diameter wire at 4.1 mm from its center is 2 kG/cm. Since a 2 kG/cm gradient will cause a cell labeled with magnetic nanoparticles to translate, but generally not be strong enough to retrieve the cell, to a first approximation, the table demonstrates the ‘magnetic-reach’ each wire diameter is capable of. Accordingly, Table I gives some insights regarding the design, complexity and placement of internal ferromagnetic structures for collecting magnetic entities in a separation vessel.

Internal magnetic gradient devices are well known in industrial application for removing weakly magnetic materials such as red iron oxides from clay to produce Kaolin. Owen and Sykes (J. Immunol. Methods 1984, 73, 41-48) introduced HGMS to biological separation by separating red cells where their hemoglobin had been oxidized. By placing small columns packed with steel wood in an external magnetic field, red cells so treated were captured. Miltenyi (EP 1 308 211 B1 ['211] and earlier unpublished work) perfected HGMS for cell separation using colloidal magnetic materials (Molday, U.S. Pat. No. 4,452,773) and non-magnetic columns packed with coated, small size (0.2-0.3 mm) magnetizable spheres. By placing such a column in an external magnetic field and subsequently removing it, magnetically labeled cells can be collected and then released. A family of separation devices based on those principles is available at Miltenyi Biotec, GmbH.

Liberti et al (U.S. Pat. No. 5,200,084) discloses an internal gradient device employing wire (0.8-3 mm) loops upon which cells can be magnetically collected. Even though magnetic gradients produced on wires of this size are substantially lower than the spheres used in '211, in concert with more magnetic ferrofluids than those used in '211, very effective cell separations can be achieved. Additionally, the larger wire diameters used, allow the loops to be moved into and out of the external magnetic field without significant deformation. Another internal gradient device for aligning cells along a thin nickel wire is disclosed in US patent to Liberti et al (U.S. Pat. No. 5,993,665). An apparatus employing both external and internal means to collect cells is disclosed in Dolan at al. (U.S. Pat. No. 5,985,153).

### SUMMARY OF THE INVENTION

From the foregoing it is clear that separation devices that employ an internal gradient are capable of producing a wide range of magnetic gradients, as well as extraordinarily high gradients, e.g., from a few gauss/cm to 100 or more kilogauss/cm. Very high gradients facilitate separations, particularly where entities of interest are targeted by magnetically responsive nanoparticles because the higher the gradient the lower the amount of magnetic label required for successful separations. Furthermore, the use of less magnetic labeling material generally results in lower carryover of unwanted materials since carryover or non-specific binding (NSB) is related to surface areas of the nano-particles used. Using less of these expensive reagents is also more cost effective.

Unfortunately, prior art devices of this kind do not readily lend themselves to separations of large volumes or to separations involving viscous media, where the intent is to recover the magnetic entities particularly of biological entities such as cells, bacteria and the like. In the case of Miltenyi '211, as well as similar, columnar devices offered by Miltenyi Biotech GmbH, there is a limit to the viscosity and complexity of materials that can be passed through such columns. Retrieval of captured entities of interest is not an easy or efficient task. Accordingly, positive selections (where the item of interest is magnetically captured and subsequently recovered) are very difficult to accomplish with the Miltenyi systems. The internal gradient device of Liberti '084, although designed for positive selections, is limited with regard to the sample size that can be processed. In addition, the device is cumbersome and would be difficult to automate. Using principles similar to the organized wires or loops disclosed in the '084 patent, it would be possible to construct flow through devices, but then hydrodynamic issues would need to be considered, as well as means for recovery of captured entities.

Disclosed herein is a novel means for magnetic separation and recovery of target entities from media that can be very viscous as well as very complex and where, in principle, separation volumes can be as large as desired. Besides separation, the nature of the system makes it capable of many other operations on the entities captured.

The operating principle of the invention for the collection and separation of target entities that are magnetic or that have been rendered magnetic by appropriate labeling with nanoparticles is the creation of an internal magnetic gradient on a ferromagnetic element which is passed through the media that contains such entities. The internal gradient is induced on the ferromagnetic element by an external magnetic field in proximity thereto. As the element is caused to move through the media, magnetic materials (entities) are collected on its surface. The shape and design of the element, in concert with the orientation of the external magnetic field, will determine the location at which collection takes place. The ferromagnetic element traverses the media, whereupon magnetic entities are collected on a surface thereof.

In accordance with one aspect of the present invention, there is provided an apparatus for separating magnetically responsive particles from a non-magnetic fluid medium including said particles. The apparatus comprises a) a containment vessel for receiving said fluid medium, the containment vessel having a longitudinal axis; b) a magnetic particle collector assembly comprising at least one ferromagnetic element and a non-magnetic shaft having a proximal end and a distal end, the distal end of the shaft being coupled to said at least one ferromagnetic element; c) a drive mechanism operably connected to the proximal end of said shaft, the drive mechanism imparting reciprocal motion to the shaft along a vertical path in substantial alignment with the longitudinal axis of said containment vessel, the drive mechanism being controllable to locate the magnetic particle collector assembly at one or more pre-selected positions in the fluid medium; and d) a magnetic field source external to the containment vessel, the magnetic field source being effective to induce a magnetic field gradient in said at least one ferromagnetic element.

The present invention also provides a method for separating a target entity from a fluid medium suspected of containing same. The method involves (a) providing an apparatus as described herein; b) mixing the fluid medium with a quantity of magnetic particles having immobilized thereon a specific binding substance that binds specifically to the target entity, under conditions causing binding of the binding substance to the target entity, thereby forming a magnetically labeled target entity; c) introducing a volume of the resulting mixture into the containment vessel of the apparatus; d) activating the drive mechanism of the apparatus, so as to submerge the ferromagnetic element into the volume of the mixture in the containment vessel; and e) inducing a magnetic field gradient in the ferromagnetic element under the influence of the external magnetic field source, the magnetic field gradient being of sufficient strength to attract the magnetically labeled target entity into contact with the ferromagnetic element and to retain the magnetically labeled target entity on the ferromagnetic element.

In one embodiment, the target entity is a biological cell, e.g., a tumor cell, having a surface receptor site and the specific binding substance is an antibody or antibody fragment that specifically binds to the receptor site.

### BRIEF DESCRIPTION OF DRAWINGS

FIG. 1 shows the components of a multi-parameter, high gradient magnetic separator embodying the present invention.

FIG. 2a-2g shows several configurations of ferromagnetic structures that are useful as collection surfaces in the magnetic separator of this invention.

### DETAILED DESCRIPTION OF THE INVENTION

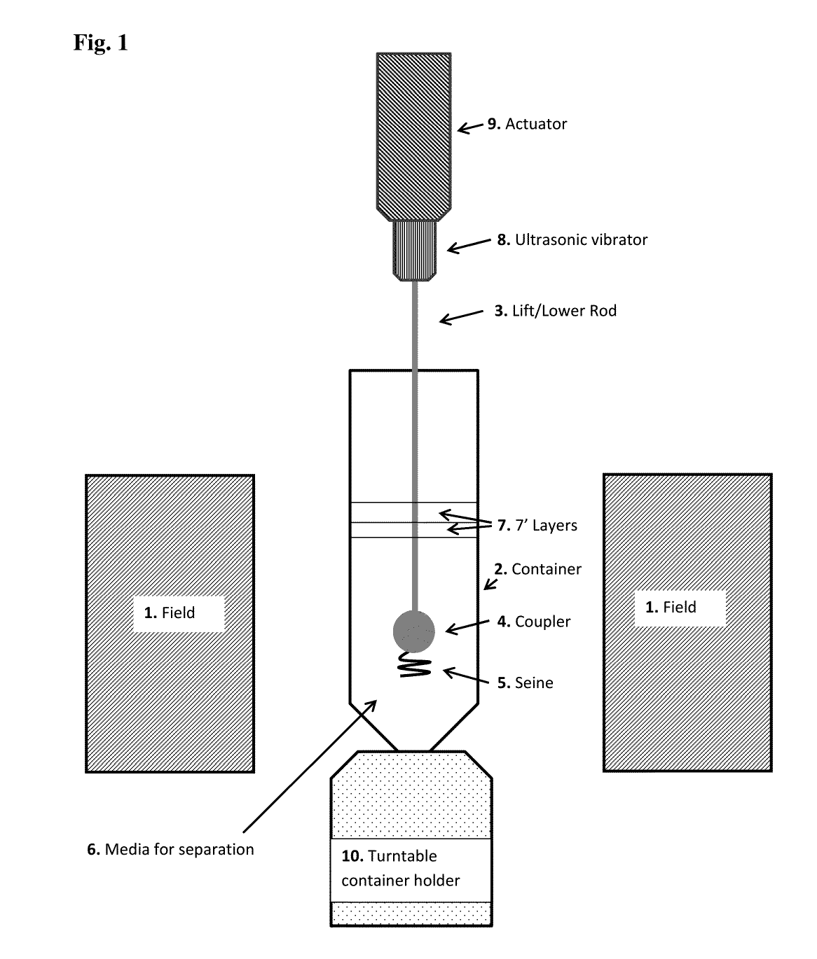

FIG. 1 shows a diagrammatic representation of the components of an apparatus effective to accomplish high-gradient magnetic separation. Non-magnetic container 2 is provided to hold the media from which target entities are to be separated. A non-magnetic, vertically displaceable rod 3 attaches to a coupler 4 that connects to a ferromagnetic element 5, upon which magnetic materials or entities that are rendered magnetic by appropriate labeling with magnetic nanoparticles are collected. Ferromagnetic element 5 and the array of alternative structures described herein that can be used for the purpose of collecting magnetic entities are sometimes referred to herein as Seines. The non-magnetic container 2 receives and holds fluid medium 6, upon which magnetic separation is performed. Additional fluid layers 7 and 8, such as wash fluid, and a labeling agent, respectively, may be dispersed upon medium 6, with the labeling agent acting upon retrieved magnetic entities collected by the Seine. The numbers of layers for performing different operations is not limited, but each successive layer should be of lighter density to keep the layers or phases from mixing. Vibrator 8 imparts vibrational energy, ultrasonic energy, or oscillating electric field to the non-magnetic rod 3 and subsequently to the Seine 5. Activator or drive mechanism 9 lifts or lowers the assembly comprising rod 3, coupler 4 and Seine 5. The actuator is programmable and has the ability to raise or lower the Seine at a controlled rate as well as being able to hold the Seine at a fixed position or oscillate it between predetermined positions. Support 10 maintains the vessel or container 2 in a fixed position, or rotates the container 2 about its vertical axis at predetermined speeds, if so desired.

Magnets 1 and 1′ are arranged so that their North-South pole pieces generate a magnetic field that induces field gradients on Seine 5. Thus, collection of magnetic entities takes place as Seine 5 traverses the fluid media.

1 and 1′ can be permanent magnets or electromagnets that can be arranged perpendicular to the Seine 5 or at other angles. Additionally, this invention can be practiced with only a single magnet for generating the inducing magnetic field. And, as those skilled in the art will recognize the inducing magnet, depending on its dimensions and orientation, can direct field lines upon the Seine such that collection takes place on the sides or top and bottom of different Seine structures that are disclosed herein.

The apparatus described herein can be used to retrieve magnetic target entities from media spanning a spectrum of viscosities and complexities. In one embodiment of this invention, analyte is separated from a biological test sample, such as, bodily fluids, culture media or environmental samples. For example, a specific cell population, e.g. a T cell subset, may be separated from a blood fraction, such as anti-coagulated blood (or washed blood cells resuspended in a suitable buffer) by employing ferrofluids bearing an appropriate monoclonal antibody (Mab). In a first step, blood is incubated with ferrofluid and placed into a test tube or some similar container. Next a layer of wash buffer of density less than blood is optionally placed on top of the incubating mixture. If so desired, subsequent layers can be added for performing additional operations on the collected cells such as labeling Mab, additional wash steps and/or other reactions. After an appropriate incubation, the vessel is placed into or onto support 10 and the actuator 9 lowers the Seine 5 at a predetermined rate for a particular separation through the above mentioned layer(s), passing into the blood mixture. As the Seine is lowered vertically through the vessel, collection of magnetically labeled cells upon the Seine occurs as it traverses the media in container 2. Once at the bottom of the container, the Seine is moved upwards to the top of the blood mixture. Collection may or may not take place as the Seine is raised, depending on the operational parameters chosen for the downward collection. Both the lowering and raising of the Seine are done at rates that effectively cause little or no perceptible disturbance of the media. Rates have been determined which enable the collection of all labeled cells in proximity of the Seine. As the Seine is raised vibrational energy, low level ultrasonic energy, or an oscillating electric field can be applied to connecting rod or shaft 3 in order to cause any cells that might have adhered non-specifically to the rod and or the coupler 4 to stay within the wash buffer layer. Cells loosely bound to the Seine by non-magnetic forces can be dislodged by this method.

Depending on the media from which target entities are to be separated, one or more wash layers can be employed. Alternatively, after the Seine has traversed a sample without added wash layers, the container can be lowered and removed while the Seine remains in the external magnetic field and a container with fresh wash buffer can be raised up to receive the Seine and complete the wash step. Similarly, additional reactions such as staining, enzymatic treatment, membrane modification and the like can be performed by methods that employ appropriate layers where such operations will take place.

Recovery of cells can be achieved in several ways. In many instances and depending on the level of magnetic labeling of the cells, there will be sufficient remnant magnetic gradient on the Seine so that it can be removed from the influence of the external magnetic field while retaining magnetically retrieved cells. In such cases, the Seine can be removed from the field and be placed in a collecting vessel containing appropriate buffer. Cells can be retrieved by the application of gentle vibration or mild ultrasonic energy or by application of an oscillating magnetic field, e.g., a demagnetizer, well known in the art.

Alternatively, it may be desirable to have cells or other magnetically captured target entities retained on a Seine in some controlled fashion when the Seine is removed from the magnetic field. That way, the operator has the ability to determine when the target entities or some fraction of them are released. The ability to retain entities on the Seine could be of substantial value in viewing such entities, in performing various reactions and analysis upon them. The ability to release all or some of the captured target entities also has benefits.

Retaining cells or other entities on a Seine can be readily achieved by the use of a specific binding pair of which there are many that will bind the target entity of interest to the Seine surface. For example, if a Goat anti Mouse Fc is coated onto the Seine and if Mouse Mab attached to ferrofluid is used for capture of the target entity, then when the entity is brought into proximity with the Seine via magnetic forces it will also be held there by the binding pair interaction. Accordingly, in the absence of an applied external field or remanant magnetic gradient on the Siene, entities remained fixed to the Siene. Thus the Siene with entities captured thereon enables a number of post capture manipulations and analyses.

It would also be desirable to release some or all of the entities magnetically captured on a Siene. There is a variety of binding pair reactions that can be readily reversed such that all entities or some predetermined subset or different species could be released in a controlled fashion. One way to accomplish that is to prepare a streptavidin ferrofluid (SAFF), and create a monoclonal antibody conjugate by binding it to mono-biotin Mab. This can be done in such a way that sufficient biotin binding sites remain free on SAFF after Mab is bound. If those excess biotin binding sites are then filled by a mono des biotin (des biotin binds at a much lower affinity than does biotin) compound, such as albumin, and if anti albumin is coated on the Seine, then when this ferrofluid conjugate comes in contact with the Seine it will be captured by the binding pair interaction (albumin::anti-albumin). By adding some simple mono biotin derivative, the des biotin conjugate will be displaced from the SAFF, thereby releasing the target entity which is attached to the SAFF via binding to the Mab. In the case of two ferrofluid Mab conjugates with different specificities (or targets) where one of the ferrofluid conjugates does not contain reversible des-biotin::streptavidin bonds, it would be clear that two entirely different populations could be magnetically captured simultaneously and one subsequently released selectively by reversing the des-biotin::streptavidin binding pair reaction.

By appropriate selection of one member of different reversible binding pairs in the construction of Mab specific ferrofluid conjugates, and the attachment of the corresponding member of the selected binding pairs on a Siene, those skilled in the art will appreciate that different entities contained in a mixture can be targeted individually, separated magnetically as disclosed herein, bound to the Seine by binding pair interactions and released in a sequential, controlled fashion.

Notably, the practice of the present invention involves a number of parameters or variables that may be controlled, either independently or in various combinations. These include: the descendent path of travel of the ferromagnetic element; the rotation of the containment vessel that brings target entities under the influence of the induced internal gradient; and the strength of the magnetic field gradient that governs the rate at which target entities are attracted to a surface of the ferromagnetic element, and the degree to which they are held there.

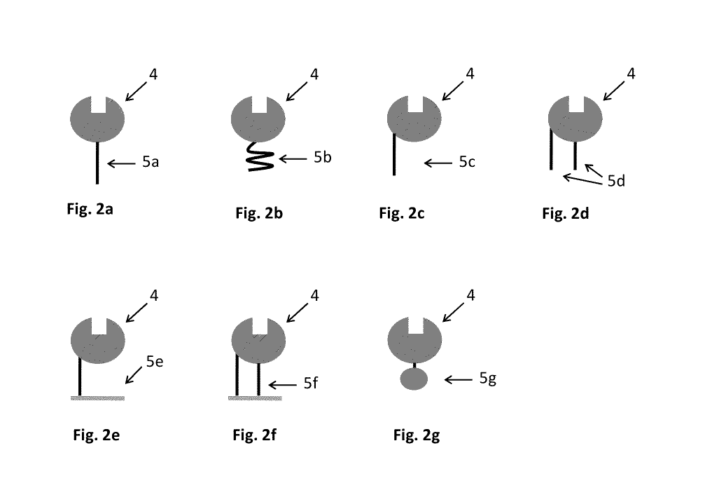

FIGS. 2a-2g depict various Seines configurations that may be attached to couplers 4 which have been found to be useful in the practice of this invention. The simplest Seine configurations are rigid ferromagnetic rods (FIG. 2a) or spheres (FIG. 2g) of various diameters made from iron, nickel and other magnetic alloys (5a shown here affixed to coupler 4 that can be attached to lift/lower rod 3 of FIG. 1).

The transverse cross-sectional dimension of rod 5a will determine the magnetic gradient that can be induced upon it. In the case where extremely high gradients are desirable and where very small diameter wires might deform in a non-uniform external field, such wires can be partially imbedded or affixed to rigid non-magnetic rods, or some appropriate support. As is well known in the art, there are various ways to imprint metallic lines or strips on non-magnetic substrates. The use of Seines in the form of very small ‘wires’ not only creates extremely large gradients but also can be used to monolayer cells on such surfaces (P. Liberti, unpublished observations, 1992, U.S. Pat. No. 6,013,188). Where few cells are expected, as might be the case for circulating tumor cells (CTCs) in a sample of blood from a cancer patient, monolayering of cells would be most advantageous in removing undesirable components as well as in processing and identification. Target entities magnetically monolayered can generally be washed free of contaminating materials without resuspension.

It has been found convenient in the construction of Seines of different designs to rigidly affix them to couplers 4 by drilling an appropriately dimensioned hole in the coupler, inserting the Seine and epoxying it in place. Small rigid plastic beads have been found useful for making couplers, but there are a variety of other non-magnetic materials and shapes that can be used. It is important that the coupler design be such that it can be submerged through solution layers causing only minimal disturbance, and retrieved without entrapping separation media, wash solutions, reaction solutions and the like. It is highly desirable that couplers either be made of materials that do not bind cells, or be coated with substances that prevent cells or other undesirable components in the media from adhering to the surface thereof. There are many commercially available coating materials that serve this purpose, which are well known to those skilled in the art (see, e.g., U.S. Pat. No. 3,723,754; French patent publication 2,089,788; Japanese application Ser. No. 45/75116; U.S. Pat. No. 5,169,720; U.S. Pat. No. 6,158,984 and U.S. Pat. No. 6,663,584.)

The attachment of a particular coupler-Seine combination is facilitated by drilling and taping into the top of the coupler. Accordingly, the combined coupler-Seine and rod 3 can engage one another by means of screw threads, e.g., with the distal end of rod 3 received by a hole in the coupler. A variety of other means for attachment including those incorporating frictional engagement are also possible. It is noteworthy that the Seine need not be affixed on the vertical axis of the coupler as is shown in FIG. 1. In some cases, as detailed below, positioning the Seine off center has significant operational advantages.

FIG. 2b depicts a cross section of a Seine 5b that is spiral in shape. This configuration is simple to fabricate as a wide variety of springs of various wire diameters and composition are readily available. Such springs can be stretched to make an appropriate configuration and can be spot heated for easy bending. Spiral configured Seines have been found to be very effective and efficient in collecting magnetic entities as they traverse a container. Clearly, the spiral Seines can be constructed so as to place collector surfaces nearly equidistant from entities to be retrieved. However, it should be noted that, because of the magnetics involved, those parts of a spiral Seine that run in a direction parallel to field lines of the external field gradient will not act as collecting surfaces on which magnetic target entities could be collected on top, bottom or sides.

For a cylindrically shaped sample containment vessel, it is possible to overcome the disadvantages noted above that are created by the physics imposed on the gradient induced on Seines. That can be accomplished by simply rotating the container about its vertical axis such that there is no, or only minimal mixing of the separation media as the Seine is lowered or raised. In that way, all entities to be collected can be brought sufficiently close to a collecting surface to be captured. It is noteworthy that conditions can readily be established where all collection takes place on the down stroke of the Seine. It should be immediately apparent to those skilled in the art that for a non-cylindrically shaped container, it would be possible to rotate such a container in a fashion where the Seine proximity to collectable entities can be maximized.

In the case of the single post Seine shown as element 5a in FIG. 2a, if a very small diameter post is used, it will have limited reach and thus not effect an efficient collection. This would be particularly the case where fine wires might be affixed to non-magnetic support posts or where ferromagnetic lines are imprinted on such a post. There are several ways in which to address such a situation where entities to be collected are, in practice, magnetically ‘out of reach’. One way is to position a single vertical post Seine off center to the axis of the container and gently rotate the container about its vertical axis. FIG. 2c depicts a single post Seine 5c, positioned off center on its coupler. When such a Seine is passaged through the media containing target entities to be separated while the container is rotated on its vertical axis, entities to be collected can be brought within reach. Where a single collecting post is insufficient for collection, a multiple post Seine 5d can be effectively employed, such as depicted in FIG. 2d. A Seine constructed in this way with multiple posts, when placed perpendicular to the external field, will collect entities on the sides penetrated by the field lines. By lowering such a Seine and rotating the container about its axis at appropriate rates all magnetic entities with sufficient magnetic moment can be collected. Another way to extend the reach of the magnetic particle collector assembly is to position the ferromagnetic element so that it projects horizontally therefrom, and generally perpendicular to the longitudinal axis of the containment vessel.

Another parameter that can be varied in practicing the invention described herein is shown in Table I. The far right-hand column lists the magnetic gradient at the surface of a non-magnetic sleeve having 0.5 mm wall thickness encasing Seine structures of various diameter rods. As is shown a rod of 1.0 mm diameter will have induced on its surface a gradient of 126 kGauss/cm. On the other hand, by placing a sleeve of 0.5 mm thickness over that rod, the gradient at the surface of the sleeve is 15.6 kGauss/cm. The dramatic drops that occur show that this is another means by which gradients can be tailored to need. Moreover, these calculations suggest that a tapered sleeve could be used advantageously to translate cells laterally to the higher gradient regions. For example, a Seine constructed with a sleeve that tapers from both directions towards some point along the sleeve should magnetically “roll” magnetically labeled cells to that point, or alternatively place them in a micro indent for easy retrieval. From microscopic studies of cell aligned on 15 micron wires on which magnetic gradients were induced, lateral movement of cells to higher gradient points has been observed. This phenomenon may be exploited as a way of concentrating cells before release or positioning them for analysis or observation.

FIG. 2e depicts a cross section of a Seine 5e formed of round wires in the shape of an “L”. Note, there is no need to restrict such wires to being round, as various cross sections such as ellipses, square or rectangular can impart advantages to this invention. Seine 5f in FIG. 2f is shown as two vertical posts joining coupler 4 to the “L” base. If the vertical parts of these Seines are significantly smaller in diameter than the base, or horizontal portion, when placed in a magnetic field, the magnetic gradients that are induced on these two different diameter parts can be made to be very substantially different (hereafter, Seines, so constructed are referred to as “compound Seines”). Further, if the vertical elements of a compound Seine are constructed of a non-magnetic post upon which are imprinted very tiny ferromagnetic lines or strips, incredibly high gradients and differential gradients with respect to the horizontal portion of such a compound Seine can be achieved.

By using compound Seines that are capable of having induced thereon two or more magnetic gradients of different magnitudes, it is possible, in a single operation, to collect sequentially two or more different target entities. This can be accomplished in one embodiment by appropriately labeling the target entities using magnetic particles that have substantially different moments. Alternatively, different target entities, having substantially different numbers of receptors, may have magnetic materials attached thereto. The former can be achieved, for example, using magnetic materials made by the method of Liberti et al [U.S. Pat. No. 5,698,271] which produces distributions of magnetic nanoparticles with diameters that range from about 60 nm to about 180 nm. From such preparations reasonably homogenous materials of 70 nm or 160 nm can be isolated, and subsequently made appropriately biospecific by coupling to specific Mabs or other targeting reagents. In the case of certain entities such as a specific cell type, bacteria, or even a specific macromolecule, it will be appreciated that labeling with the smaller of the two aforementioned ferrofluids gives rise to entities that require a substantially higher magnetic gradient in order to be collected than would be the case had they been labeled with the larger (160 nm) material. Consequently, when two (or more) different target entities are labeled with magnetic nano-particles that are of different sizes or particles of different magnetic moments, they would be collected on components of compound Seines in accordance with the gradients induced on the component parts thereof.

By moving a compound Seine, capable of having induced on two or more of its component parts substantially different magnetic gradients, through a vessel containing two or more target entities labeled with substantially different sized magnetic nanoparticles, different populations are collected on different parts of the compound Seine. In such embodiments, rotating the vessel or container containing the sample to be separated is advantageous in bringing the different populations into proximity to the collecting surfaces.

In using an “L” shaped compound Seine, as depicted in FIGS. 2e and 2f, or some similar construction, it will be appreciated that the upper collection surface, i.e. the vertical post portions of the compound Seine, would have to traverse the entire media to collect all target entities that require exposure to the higher magnetic gradient in order to be collected. To reduce the possibility that the lower horizontal portion or “foot” of the compound Seine would spatially interfere with efficient target entity collection, the sample to be separated can be layered over some denser media. For example, by first placing an amount of a dense solution, e.g. a concentrated sucrose solution, into the separation container, thus forming a ‘cushion’, material to be separated could be layered upon it. In that way, the compound Seine could move through the entire sample. Thus, both collecting surfaces of a compound Seines, would have equal exposure to the entire sample from which target entities are to be separated.

In this manner, a negative selection where undesired entities are selectively collected on the leading low gradient portion of the Seine (FIGS. 2e, 2f and similar structures) could effectively be done in concert with a positive selection where collection takes place on the very high gradient portion of the compound Seine. This approach provides a unique means of discrimination and selection and would be immensely valuable and time savings as regards many applications, such as rare cell isolation. Accordingly, the magnetic separator described herein could be of significant value to the field of circulating tumor cell detection which has now become an area of world-wide endeavor, as well as detection of other rare cells, such as stem cells and the like. There are a variety of ways to retrieve the two populations thus collected, as would be clear to those skilled in the art.

Alternatively, if there is no need to retrieve the negatively selected entity(ies), it would be a simple task to passage the compound Seine through the sample and down into the dense cushion layer and discard any unwanted cells by a mechanism effective to leave that portion of the compound Seine and its captured entities behind. Thus a compound Seine is passed through the sample, performs appropriate selection on different portions of the surface thereof, moves into the cushion layer, leaves the lower portion of the compound Seine in the region of the cushion and then moves out of the sample retaining only those desired entities which have been collected on the very high gradient portion of the compound Seine. There are several ways to dislodge the foot portion of a compound Seine. These include having it engage a groove or other receptacle, or set of diametrically opposed recesses or projections, formed in the bottom portion of the separation vessel, and simply twist it off.

As previously mentioned, in some embodiments, the “foot” or base member of a compound Seine may be encased in a non-magnetic sleeve that acts to lower the surface gradient. A vertical rod not sleeved has a significantly higher gradient than one that is sleeved. Notably, incorporating a sleeve over a collector rod has two effects. First, a sleeve lowers the gradient; and secondly, it provides a convenient way in which to create a larger collection surface. By making the surface of sleeves uneven, such as by making them microscopically sinusoidal or undulating even further collecting area should be achievable without entrapping cells or other analytes.

A variety of external magnetic field arrangements can be used in the practice of this invention, the only requirement being that sufficient external field lines traverse the Seine so as to induce an appropriate internal gradient. The external magnetic field can be generated by a North-South magnetic arrangement as depicted in FIG. 1, which can be permanent or electro-magnetic. Rare earth (neodymium-iron-boron) permanent block magnets 0.5″ thick (magnetic direction) by 2″×4″ oriented vertically and positioned in a North-South configuration with a 1.0″ gap are quite adequate for doing separations in standard 12×75 mm test tubes.

The field created by the external magnets can be homogeneous using appropriate magnet pole face design in which case there are no gradient forces towards the external magnets. Alternatively, the external field can be such that there is some gradient directed to each pole face. In such cases, it has been found that magnetically labeled cells migrate towards the sides of the container even though they will not collect on the inner walls of the container. This phenomenon can be used to advantage as collectable material is brought within reach of an appropriately designed Seine.

In the practice of this invention there is also no need to have the entire sample within the external magnetic field. An external magnetic field that creates a band that encompasses the Seine is adequate. In that way the ‘band’ would follow the movement of the Seine. Alternatively, the magnetic band and the Seine could remain stationary and the vessel moved, such that all portions of the vessel contents are brought into contact with the collecting surface(s). There are situations where that arrangement will be advantageous.

Where the field lines are directed perpendicular to Seines, as would be the case for the orientation depicted in FIG. 1, collection takes place on the surfaces of the Seine facing the external magnets. As this invention can be practiced with external fields generated from a single magnet positioned in various orientations with respect to a Seine, it will be clear to those skilled in the art that collection can be made to occur on different surfaces of the Seine, including top and bottom.

It is noted that the gradient produced on any Seine is also a function of external field intensity. Accordingly, variation of field intensity can be used as another variable in the separation system described herein, for finely tuning the gradients induced on the Seine. Lastly, alternative means for removing the effects of the external field on a Siene can be achieved by employing a hinged yoke or an appropriate electromagnet.

The following example describes the invention in further detail. These examples are provided for illustrative purposes only and should in no way be construed as limiting the invention or its applicability.

### Example 1

### Construction of Simple Prototype, FF Removal and T Cell Capture

A sufficiently uniform magnetic field for inducing magnetic gradients on Seines was created by constructing dipole magnet from a “U” shaped yoke having soft steel sides of 4.0×4.5×0.5″ and a back plate that held the sides apart by 2.0″, wherein 3.0×2.5 by 0.5 inch block magnets (magnetized through the 0.5″ dimension) were affixed to the inside walls of the yoke in a North-South orientation, and separated by a gap distance of 1.0″. This arrangement creates a gap volume of 3×2.5×1″. 3.0×0.5×0.4 inch magnets (magnetized through the 0.4″ dimension) were placed adjacent to and in the same orientation on both vertical sides of the large block magnets in order to keep the field lines resulting from the magnetic circuit of the large block magnets from bulging out (and creating gradients); thus creating a substantial volume between the large block magnets where a ferromagnetic object could be moved into, out of and within this volume with minimal attraction to either block magnet. The absence of substantial gradients in the mid region of the gap where a separation tube would be placed to perform a Seine collection was confirmed by placing a solution of 140 nm ferrofluid at 100 ug/ml in a test tube and letting the solution stand for up to 15 minutes with no evidence of ferrofluid separation.

A vertical elevator for controlling the position of a Seine, where raising and lowering rates could be carefully controlled, was fashioned from camera slider mounted vertically, purchased from ServoCity.com. The elevator arrangement allowed Seines to be lowered and raised at rates as low as 0.4 cm/minute. A mount for holding 12×75 mm tubes was constructed from a short length of acrylic rod (0.75″ diameter) where one end was milled such that the bottom of a tube would insert 0.5 cm and be held steady by friction. The other end of the acrylic rod was affixed to the shaft of a 3-12V geared motor (ServoCity.com) that could be rotated at rates from 2-8 rpm. This arrangement was affixed to a mounting plate that positions the tube within the gap of the yoked dipole and that can be aligned vertically with the path of a Seine. The mounting plate could also be moved off center to vertical such that a Seine passaging through the separation vessel could be made to passage off center and at position midway between the vertical axis and one inner side of the separation tube.

When a 1.0 mm diameter and 1.5 cm length iron rod Seine was passaged through 4.0 mls of the above mentioned ferrofluid placed in a 12×75 mm tube rotated off axis of the Seine as described above, at a tube rotation rate of 4 rpm and a Seine down and up cycle time of 2.5 minutes, ferrofluid was completely cleared from the tube.

To test the capability of the above arrangement for cell separation, peripheral blood-derived T-lymphoblast cell line (CEM) was grown in RPMI-1640 media, supplemented with 10% fetal bovine serum (FBS) at cell concentrations ranging from 4×10⁵ to 1×10⁶ cells/mL. Cell growth media was replenished every 3 days. The CEM cells were centrifuged at 100 g for 10 minutes and re-suspended in DPBS, supplemented with 0.5% BSA at a concentration of 10⁸ cells/mL. The cells were labeled with 0.1 ug of biotinylated mouse anti-human CD3 antibody per 100 ul of cells for 10 minutes at room temperature. The cell suspension was diluted and washed via centrifugation. Antibody-labeled cells were mixed with streptavidin-coupled ferrofluid for 10 minutes at room temperature and diluted to a concentration of 10⁶ cells/mL. in a total volume of 1 mL. The cell-containing tube was placed in the Ultra-high gradient magnetic separator and a simple vertical Seine 2.0 cm in length and of 1.5 mm diameter steel rod was lowered into the cell suspension at a controlled rate (0.8 cm/min) while the tube was rotated at a constant rate of 2 rev/min. The rod was then slowly raised from the cell suspension for a total rod-cell contact time of 3 minutes. The number of cells that remained in the tube was counted and it was calculated that 73% of the starting cell suspension was collected on the rod. From the visible ‘coating’ of cells on the Seine it was evident that the Seine's capacity had been exceeded. At lower levels of labelled cells, supernatants were visibly clear indicating high levels of cell capture.

### Example 2

### Preparation of Sienes Barrier Coatings that Modify Effective Induced Magnetic Gradients

There are instances where it is desirable to coat ferromagnetic rods used in constructing Seines just for the purpose of affording easy release of magnetically collected entities and materials for doing that have been cited. Alternatively where it is desirable to modulate the gradient of a Seine of some particular diameter Ferromagnetic rods, e.g. iron, nickel, used to create Sienes, such rods or structures can be encapsulated with micro-tubing that is nontoxic, non-pyrogenic and biocompatible, thereby in a virtual manner effectively increasing the diameter of the rod and thus lowering the gradient that captured entities experience at the Seine surface. This can readily be done with commercially available tubes (i.e. microprobe tubing) that is stiff enough for easy handling and soft enough to resist puncturing. The inner diameter of such tubes can be as small as 1 mm, or be made smaller by stretching, and simply slipped over the end of the rods until the entire rod is covered with the material. To create a variable ‘barrier’ thickness along a Sienes such that the surface gradient changes gradually along the length of the Seine, tubing is simply stretched from one end while keeping the other end fixed. Additionally, by placing a moderate source of heating at the very center of a rod so encapsulated and pulling on both ends, it is possible to create a Seine that has a region of higher gradient at its center and lower gradient on its end. Thus magnetic entities that land on a region of greater barrier thickness can be made to roll to the region of lesser diameter barrier, i.e. to the higher gradient region. With micro fabrication techniques, it would be possible to construct barrier sleeves where cells could be made to ‘roll’ into individual wells. Additionally simply stretching tubing placed over ferromagnetic rods will alter the thickness of the barrier and thus modulate the gradient at the Seine surface, or in the case of other Seine shapes varying coating thickness will achieve the same end.

A number of patent and non-patent publications are cited herein in order to describe the state of the art to which this invention pertains. The entire disclosure of each of these publications is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All devices, device components and methods described herein that embody the present invention can, in alternate embodiments, be more specifically defined by any of the transitional terms “comprising,” “consisting essentially of,” and “consisting of.”

What is claimed is:

1. Apparatus for separating magnetically responsive particles from a non-magnetic fluid medium including said particles, said apparatus comprising:
a) a containment vessel for receiving said fluid medium, said containment vessel having a longitudinal axis;
b) a magnetic particle collector assembly comprising at least one ferromagnetic element and a non-magnetic shaft having a proximal end and a distal end, the distal end of said shaft being coupled to said at least one ferromagnetic element;
c) a drive mechanism operably connected to the proximal end of said shaft, said drive mechanism imparting reciprocal motion to said shaft along a vertical path in substantial alignment with the longitudinal axis of said containment vessel, said drive mechanism being controllable to locate said magnetic particle collector assembly at one or more pre-selected positions in said fluid medium; and
d) a magnetic field source external to said containment vessel, said magnetic field source being effective to induce a magnetic field gradient in said at least one ferromagnetic element.

2. The apparatus of claim 1, further comprising a rotatable base supporting said containment vessel.

3. The apparatus of claim 1, wherein said shaft and said ferromagnetic element are coupled by an adaptor.

4. The apparatus of claim 3, wherein said ferromagnetic element has a first end and a second end and is in a form selected from the group consisting of a rod, a wire, a pin and a filament.

5. The apparatus of claim 4, wherein said shaft is cylindrical and said at least one ferromagnetic element has the first end thereof coupled to said shaft by said adaptor, which has a cross-sectional dimension greater than the shaft diameter.

6. The apparatus of claim 5 having a single ferromagnetic element substantially aligned with the longitudinal axis of said collection vessel.

7. The apparatus of claim 5 having a single ferromagnetic element spaced apart from the longitudinal axis of said containment vessel and generally parallel to said longitudinal axis.

8. The apparatus of claim 7 further comprising an appendage attached perpendicularly to the second end of said ferromagnetic element.

9. The apparatus of claim 8, wherein said appendage is removably attached to said ferromagnetic element.

10. The apparatus of claim 5 having at least two ferromagnetic elements, one of said ferromagnetic elements being substantially aligned with the longitudinal axis of said containment vessel and another said ferromagnetic elements being generally parallel to said longitudinal axis.

11. The apparatus of claim 10 further comprising an appendage attached perpendicularly to at least one second end of said ferromagnetic elements.

12. The apparatus of claim 11, wherein said appendage is removably attached to said ferromagnetic element(s).

13. The apparatus of claim 3, wherein said adaptor has a body portion and an elongated protuberance extending from said body portion, said ferromagnetic element being affixed to said protuberance.

14. The apparatus of claim 13, wherein said adaptor has a spherical body portion and said elongated protuberance extends from said body substantially aligned with and/or generally parallel to the longitudinal axis of said containment vessel.

15. The apparatus of claim 14, wherein multiple ferromagnetic elements are affixed to said elongated protuberance.

16. The apparatus of claim 15, wherein at least two of said ferromagnetic elements have a difference in at least one of a longitudinal dimension and a transverse cross-sectional dimension relative to one another.

17. The apparatus of claim 3, having a single ferromagnetic element of spiral form, said spiral having a longitudinal axis substantially aligned with the longitudinal axis of said containment vessel.

18. A method for separating a target entity from a fluid medium suspected of containing said target entity, said method comprising:
a) providing an apparatus as claimed in claim 1;
b) mixing said fluid medium with a quantity of magnetic particles having immobilized thereon a specific binding substance that binds specifically to said target entity, under conditions causing binding of said binding substance to said target entity, thereby forming a magnetically labeled target entity;
c) introducing a volume of said mixture into the containment vessel of said apparatus;
d) activating the drive mechanism of said apparatus, so as to submerge the at least one ferromagnetic element into the volume of said mixture in said containment vessel; and
e) inducing a magnetic field gradient in said ferromagnetic element under the influence of said magnetic field source, said magnetic field gradient being of sufficient strength to attract said magnetically labeled target entity into contact with said ferromagnetic element and to retain said magnetically labeled target entity on said ferromagnetic element.

19. The method of claim 18, further comprising introducing into said containment vessel a wash solution that forms a supernatant layer on said fluid medium, and retracting said ferromagnetic element through said supernatant layer.

20. The method of claim 18, wherein said target entity is a biological cell having a surface receptor site and said specific binding substance is an antibody or antibody fragment that specifically binds to said receptor site.

21. The method of claim 20, wherein said biological cell is a tumor cell and said surface receptor site is an EpCAM receptor site.
